(19) United States
(12) Patent Application Publication
(10) Pub. No.: US 2004/0166368 A1
(43) Pub. Date: Aug. 26, 2004

(54) AP-tab spin valve with controlled magnetostriction of the biasing layer

(75) Inventors: Hardayal Singh Gill, Palo Alto, CA (US); Neil Smith, San Jose, CA (US); Alexander Michael Zeltser, San Jose, CA (US)

Correspondence Address: William D. Gill, IBM Corporation, Intellectual Property Law, (L2PA/010), 5600 Cottle Road, San Jose, CA, 95193, US

(73) Assignee: International Business Machines Corporation, Armonk, NY

(21) Appl. No.: 10/374,049

(22) Filed: Feb. 24, 2003

(51) Int. Cl. B32B 9/00

(52) U.S. Cl. 428/692; 360/314

(57) ABSTRACT

A spin valve sensor with a self-pinned antiparallel coupled bias layer having a high uniaxial anisotropy caused by lapping-induced stress is provided. A ferromagnetic bias layer having a thickness greater than the thickness of the free layer is antiparallel (AP)-coupled to the free layer in first and second passive regions. The ferromagnetic bias layer is formed of material having a net negative magnetostriction coefficient resulting in a high value of stress-induced anisotropy field parallel to the ABS for strong self-pinning of the bias layer in the first and second passive regions.

### BACKGROUND OF THE INVENTION

1. Field of the Invention

This invention relates in general to spin valve magnetoresistive sensors for reading information signals from a magnetic medium and, in particular, to a lead overlay spin valve sensor with controlled magnetostriction of the biasing layer for pinning an antiparallel coupled lead sensor overlap (tab) region.

2. Description of Related Art

Computers often include auxiliary memory storage devices having media on which data can be written and from which data can be read for later use. A direct access storage device (disk drive) incorporating rotating magnetic disks is commonly used for storing data in magnetic form on the disk surfaces. Data is recorded on concentric, radially spaced tracks on the disk surfaces. Magnetic heads including read sensors are then used to read data from the tracks on the disk surfaces.

In high capacity disk drives, magnetoresistive (MR) read sensors, commonly referred to as MR sensors, are the prevailing read sensors because of their capability to read data from a surface of a disk at greater track and linear densities than thin film inductive heads. An MR sensor detects a magnetic field through the change in the resistance of its MR sensing layer (also referred to as an “MR element”) as a function of the strength and direction of the magnetic flux being sensed by the MR layer.

The conventional MR sensor operates on the basis of the anisotropic magnetoresistive (AMR) effect in which an MR element resistance varies as the square of the cosine of the angle between the magnetization in the MR element and the direction of sense current flowing through the MR element. Recorded data can be read from a magnetic medium because the external magnetic field from the recorded magnetic medium (the signal field) causes a change in the direction of magnetization in the MR element, which in turn causes a change in resistance in the MR element and a corresponding change in the sensed current or voltage.

Another type of MR sensor is the giant magnetoresistance (GMR) sensor manifesting the GMR effect. In GMR sensors, the resistance of the MR sensing layer varies as a function of the spin-dependent transmission of the conduction electrons between magnetic layers separated by a nonmagnetic layer (spacer) and the accompanying spin-dependent scattering which takes place at the interface of the magnetic and nonmagnetic layers and within the magnetic layers. GMR sensors using only two layers of ferromagnetic material (e.g., Ni—Fe) separated by a layer of nonmagnetic material (e.g., copper) are generally referred to as spin valve (SV) sensors manifesting the SV effect.

FIG. 1 shows an SV sensor 100 comprising end regions 104 and 106 separated by a central region 102. A first ferromagnetic layer, referred to as a pinned layer 120, has its magnetization typically fixed (pinned) by exchange coupling with an antiferromagnetic (AFM) layer 125. The magnetization of a second ferromagnetic layer, referred to as a free layer 110, is not fixed and is free to rotate in response to the magnetic field from the recorded magnetic medium (the signal field). The free layer 110 is separated from the pinned layer 120 by a non-magnetic, electrically conducting spacer layer 115. Hard bias layers 130 and 135 formed in the end regions 104 and 106, respectively, provide longitudinal bias for the free layer 110. Leads 140 and 145 formed on hard bias layers 130 and 135, respectively, provide electrical connections for sensing the resistance of SV sensor 100. In the SV sensor 100, because the sense current flow between the leads 140 and 145 is in the plane of the SV sensor layers, the sensor is known as a current-in-plane (CIP) SV sensor. IBM's U.S. Pat. No. 5,206,590 granted to Dieny et al. discloses a GMR sensor operating on the basis of the SV effect.

Another type of spin valve sensor is an antiparallel (AP)-pinned spin valve sensor. The AP-pinned spin valve sensor differs from the simple spin valve sensor in that an AP-pinned structure has multiple thin film layers instead of a single pinned layer. The AP-pinned structure has an antiparallel coupling (APC) layer sandwiched between first and second ferromagnetic pinned layers. The first pinned layer has its magnetization oriented in a first direction by exchange coupling to the antiferromagnetic pinning layer. The second pinned layer is immediately adjacent to the free layer and is antiparallel exchange coupled with the first pinned layer because of the selected thickness (in the order of 8 Å) of the APC layer between the first and second pinned layers. Accordingly, the magnetization of the second pinned layer is oriented in a second direction that is antiparallel to the direction of the magnetization of the first pinned layer.

The AP-pinned structure is preferred over the single pinned layer because the magnetizations of the first and second pinned layers of the AP-pinned structure subtractively combine to provide a net magnetization that is less than the magnetization of the single pinned layer. The direction of the net magnetization is determined by the thicker of the first and second pinned layers. A reduced net magnetization equates to a reduced demagnetization field from the AP-pinned structure. Since the antiferromagnetic exchange coupling is inversely proportional to the net pinning magnetization, this increases exchange coupling between the first pinned layer and the antiferromagnetic pinning layer. An AP-pinned spin valve sensor is described in commonly assigned U.S. Pat. No. 5,465,185 to Heim and Parkin.

A typical spin valve sensor has top and bottom surfaces and first and second side surfaces which intersect at an air bearing surface (ABS) where the ABS is an exposed surface of the sensor that faces the magnetic disk. Prior art read heads employ first and second hard bias layers and first and second lead layers that abut the first and second side surfaces for longitudinally biasing and stabilizing the free layer in the sensor and conducting a sense current transversely through the sensor. The track width of the head is measured between the centers of the side surfaces of the free layer. In an effort to reduce the track width to submicron levels it has been found that the hard bias layers make the free layer magnetically stiff so that its magnetic moment does not freely respond to field signals from a rotating magnetic disk. Accordingly, there is a strong-felt need to provide submicron track width spin valve sensors which are still sensitive to the signals from the rotating magnetic disk along with longitudinal biasing of the free layer transversely so that the free layer is kept in a single magnetic domain state. In very high capacity drives there is an additional need for a spin valve sensor having a thin layer structure in order to provide the desired high read resolution.

### SUMMARY OF THE INVENTION

Accordingly, it is an object of the present invention to disclose a spin valve sensor with a highly stabilized free layer which is highly responsive to signals from a rotating magnetic disk.

It is another object of the present invention to disclose a spin valve sensor with a self-pinned antiparallel coupled bias layer in the lead/sensor overlap region.

It is yet another object of the present invention to disclose a spin valve sensor having a ferromagnetic bias layer in the lead overlap regions formed of materials having a negative magnetostriction coefficient.

It is a further object of the present invention to disclose a spin valve sensor having a self-pinned ferromagnetic bias layer in the lead overlap regions comprising a first bias sublayer for providing strong antiferromagnetic coupling to the free layer and a second bias sublayer having a negative magnetostriction coefficient for providing strong self-pinning.

In accordance with the principles of the present invention, there is disclosed an embodiment of the present invention wherein a spin valve (SV) sensor has a transverse length between first and second side surfaces which is divided into a track width region between first and second passive regions wherein the track width region is defined by first and second lead layers. The SV sensor comprises a pinned layer, a spacer layer and a free layer, wherein the free layer is at the top of the sensor. A ferromagnetic bias layer having a thickness greater than the thickness of the free layer is antiparallel (AP) coupled to the free layer in the first and second passive regions. The ferromagnetic bias layer is formed of material having a negative magnetostriction coefficient. Since SV sensors formed on Al₂O₃ substrates are generally under compressive stress in the plane of the ABS, the use of material having a large negative magnetostriction coefficient results in a high value of the stress induced anisotropy field parallel to the ABS for strong self-pinning of the bias layer in the first and second passive regions.

The total uniaxial anisotropy field, H_{K}, of ferromagnetic materials is the sum of the intrinsic uniaxial anisotropy field, Hₖ, and the stress induced uniaxial anisotropy field, H_{σ}. The intrinsic uniaxial anisotropy field, Hₖ, often simply referred to as the uniaxial anisotropy field, is normally controlled by application of a magnetic field during film growth, or by other conditions of film deposition. The stress induced uniaxial anisotropy field, H_{σ}, is proportional to the product of the magnetostriction coefficient, λ, of the ferromagnetic material and the tensile or compressive stress, σ, applied to the material. SV sensors formed on Al₂O₃ substrates are generally under compressive stress in the plane of the ABS, so that use of materials having high negative magnetostriction coefficients will result in the high values of H_{σ} parallel to the ABS desired for strong self-pinning of the bias layer of the present invention.

In the present invention, materials for the bias layer having high values of negative saturation magnetostriction (λₛ) and high intrinsic uniaxial anisotropy (Hₖ) are preferred. For the present purposes, high saturation magnetostriction is defined as λₛ≦−5×10⁻⁶ and high intrinsic uniaxial anisotropy is defined as Hₖ≧10 Oe.

In a first embodiment, the ferromagnetic bias layer comprises a first bias sublayer for providing strong antiferromagnetic coupling to the free layer and a second bias sublayer having a high negative magnetostriction coefficient for providing strong self-pinning. In a second embodiment, a SV sensor with a single bias layer having negative magnetostriction for strong self-pinning is disclosed.

The above as well as additional objects, features, and advantages of the present invention will become apparent in the following written description.

### BRIEF DESCRIPTION OF THE DRAWINGS

For a fuller understanding of the nature and advantages of the present invention, as well as of the preferred mode of use, reference should be made to the following detailed description read in conjunction with the accompanying drawings. In the following drawings, like reference numerals designate like or similar parts throughout the drawings.

FIG. 1 is an air bearing surface view, not to scale, of a prior art SV sensor;

FIG. 2 is a simplified diagram of a magnetic recording disk drive system using the SV sensor of the present invention;

FIG. 3 is a vertical cross-section view, not to scale, of a “piggyback” read/write magnetic head;

FIG. 4 is a vertical cross-section view, not to scale, of a “merged” read/write magnetic head;

FIG. 5 is an air bearing surface view, not to scale, of a first embodiment of a lead overlay SV sensor of the present invention; and

FIG. 6 is an air bearing surface view, not to scale, of a second embodiment of a lead overlay SV sensor of the present invention.

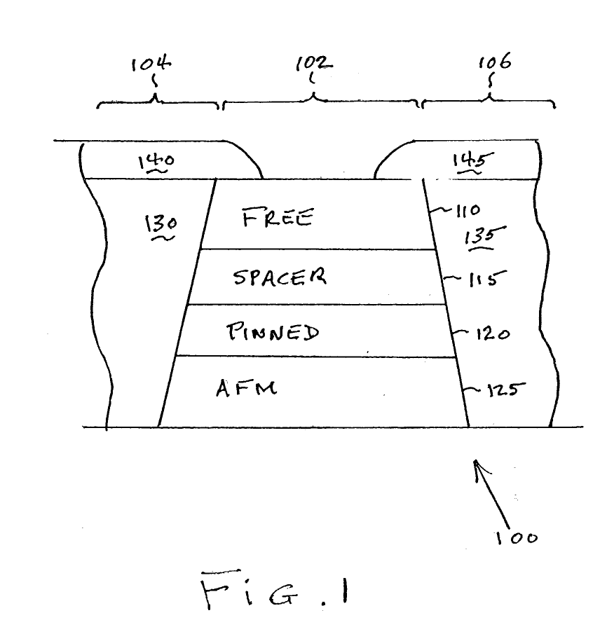

### DETAILED DESCRIPTION OF THE PREFERRED EMBODIMENT

The following description is the best embodiment presently contemplated for carrying out the present invention. This description is made for the purpose of illustrating the general principles of the present invention and is not meant to limit the inventive concepts claimed herein.

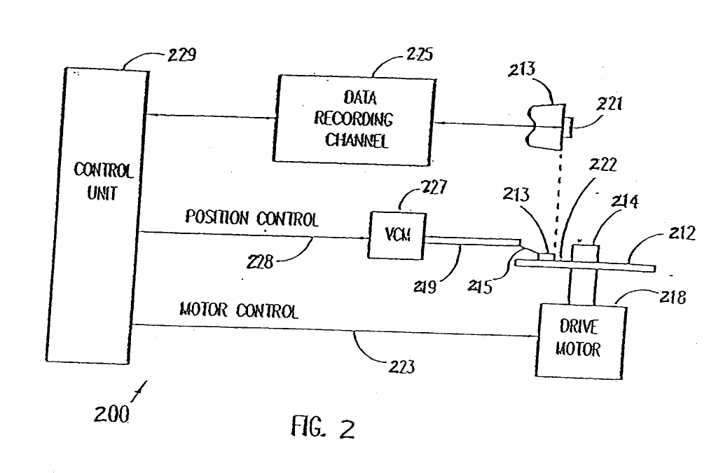

Referring now to FIG. 2, there is shown a disk drive 200 embodying the present invention. As shown in FIG. 2, at least one rotatable magnetic disk 212 is supported on a spindle 214 and rotated by a disk drive motor 218. The magnetic recording media on each disk is in the form of an annular pattern of concentric data tracks (not shown) on the disk 212.

At least one slider 213 is positioned on the disk 212, each slider 213 supporting one or more magnetic read/write heads 221 where the head 221 incorporates the SV sensor of the present invention. As the disks rotate, the slider 213 is moved radially in and out over the disk surface 222 so that the heads 221 may access different portions of the disk where desired data is recorded. Each slider 213 is attached to an actuator arm 219 by means of a suspension 215. The suspension 215 provides a slight spring force which biases the slider 213 against the disk surface 222. Each actuator arm 219 is attached to an actuator 227. The actuator as shown in FIG. 2 may be a voice coil motor (VCM). The VCM comprises a coil movable within a fixed magnetic field, the direction and speed of the coil movements being controlled by the motor current signals supplied by a controller 229.

During operation of the disk storage system, the rotation of the disk 212 generates an air bearing between the slider 213 (the surface of the slider 213 which includes the head 321 and faces the surface of the disk 212 is referred to as an air bearing surface (ABS)) and the disk surface 222 which exerts an upward force or lift on the slider. The air bearing thus counter-balances the slight spring force of the suspension 215 and supports the slider 213 off and slightly above the disk surface by a small, substantially constant spacing during normal operation.

The various components of the disk storage system are controlled in operation by control signals generated by the control unit 229, such as access control signals and internal clock signals. Typically, the control unit 229 comprises logic control circuits, storage chips and a microprocessor. The control unit 229 generates control signals to control various system operations such as drive motor control signals on line 223 and head position and seek control signals on line 228. The control signals on line 228 provide the desired current profiles to optimally move and position the slider 213 to the desired data track on the disk 212. Read and write signals are communicated to and from the read/write heads 221 by means of the recording channel 225. Recording channel 225 may be a partial response maximum likelihood (PRML) channel or a peak detect channel. The design and implementation of both channels are well known in the art and to persons skilled in the art. In the preferred embodiment, recording channel 225 is a PRML channel.

The above description of a typical magnetic disk storage system, and the accompanying illustration of FIG. 2 are for representation purposes only. It should be apparent that disk storage systems may contain a large number of disks and actuator arms, and each actuator arm may support a number of sliders.

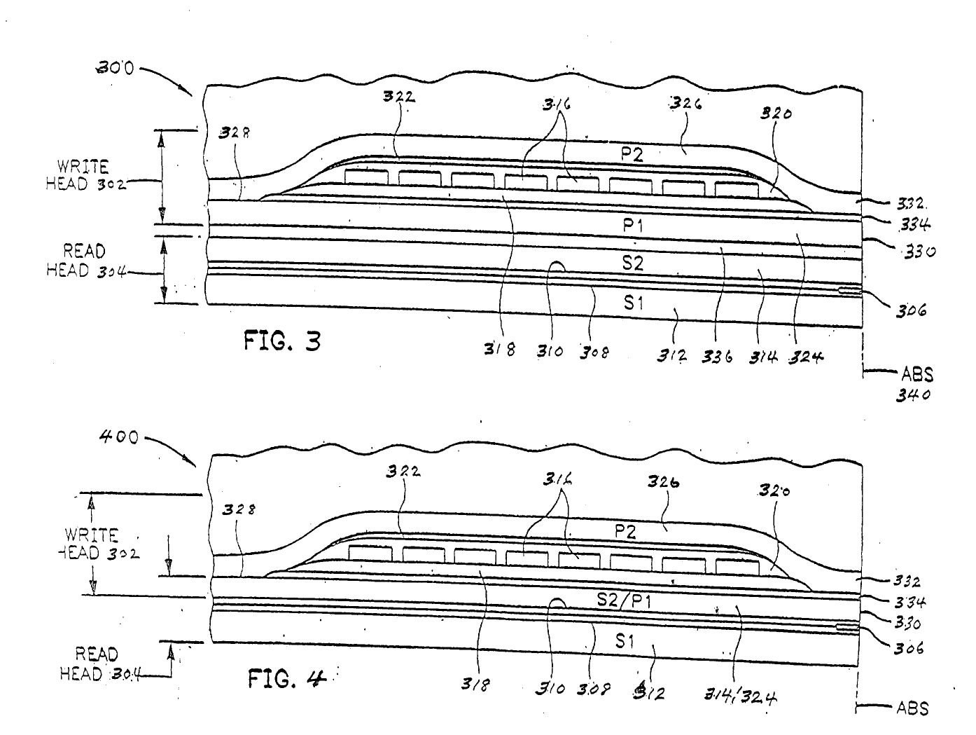

FIG. 3 is a side cross-sectional elevation view of a “piggyback” magnetic read/write head 300, which includes a write head portion 302 and a read head portion 304, the read head portion employing a spin valve sensor 306 according to the present invention. The sensor 306 is sandwiched between nonmagnetic insulative first and second read gap layers 308 and 310, and the read gap layers are sandwiched between ferromagnetic first and second shield layers 312 and 314. In response to external magnetic fields, the resistance of the sensor 306 changes. A sense current Is conducted through the sensor causes these resistance changes to be manifested as potential changes. These potential changes are then processed as readback signals by the processing circuitry of the data recording channel 246 shown in FIG. 2.

The write head portion 302 of the magnetic read/write head 300 includes a coil layer 316 sandwiched between first and second insulation layers 318 and 320. A third insulation layer 322 may be employed for planarizing the head to eliminate ripples in the second insulation layer 320 caused by the coil layer 316. The first, second and third insulation layers are referred to in the art as an insulation stack. The coil layer 316 and the first, second and third insulation layers 38, 320 and 322 are sandwiched between first and second pole piece layers 324 and 326. The first and second pole piece layers 324 and 326 are magnetically coupled at a back gap 328 and have first and second pole tips 330 and 332 which are separated by a write gap layer 334 at the ABS 340. An insulation layer 336 is located between the second shield layer 314 and the first pole piece layer 324. Since the second shield layer 314 and the first pole piece layer 324 are separate layers this read/write head is known as a “piggyback” head.

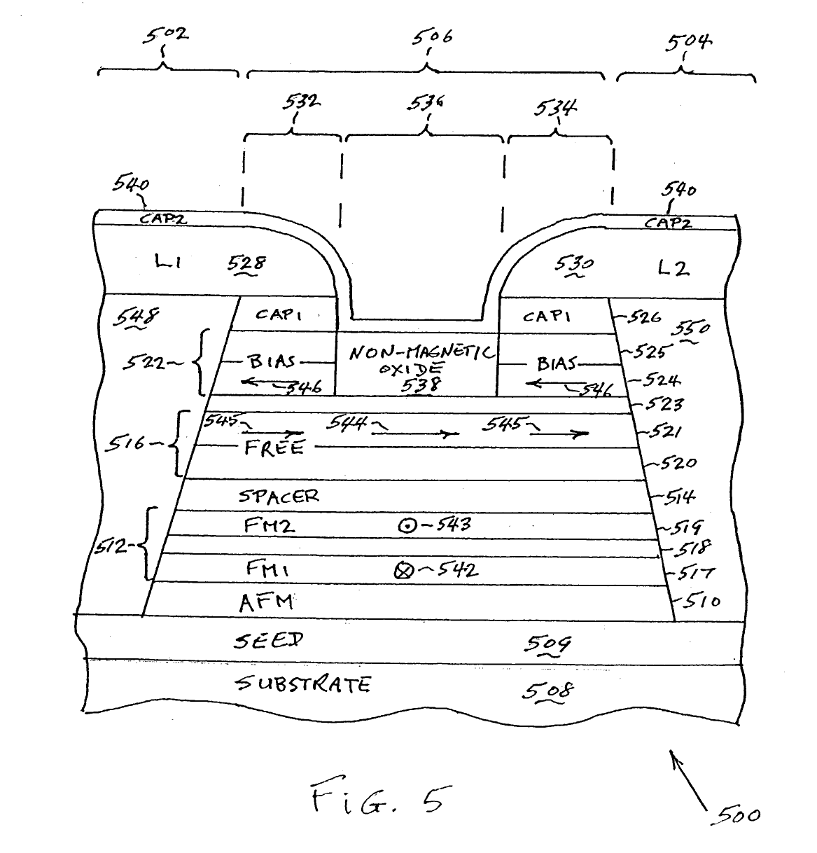

FIG. 4 is the same as FIG. 3 except the second shield layer 414 and the first pole piece layer 424 are a common layer. This type of read/write head is known as a “merged” head 400. The insulation layer 336 of the piggyback head in FIG. 3 is omitted in the merged head 400 of FIG. 4.

### FIRST EXAMPLE

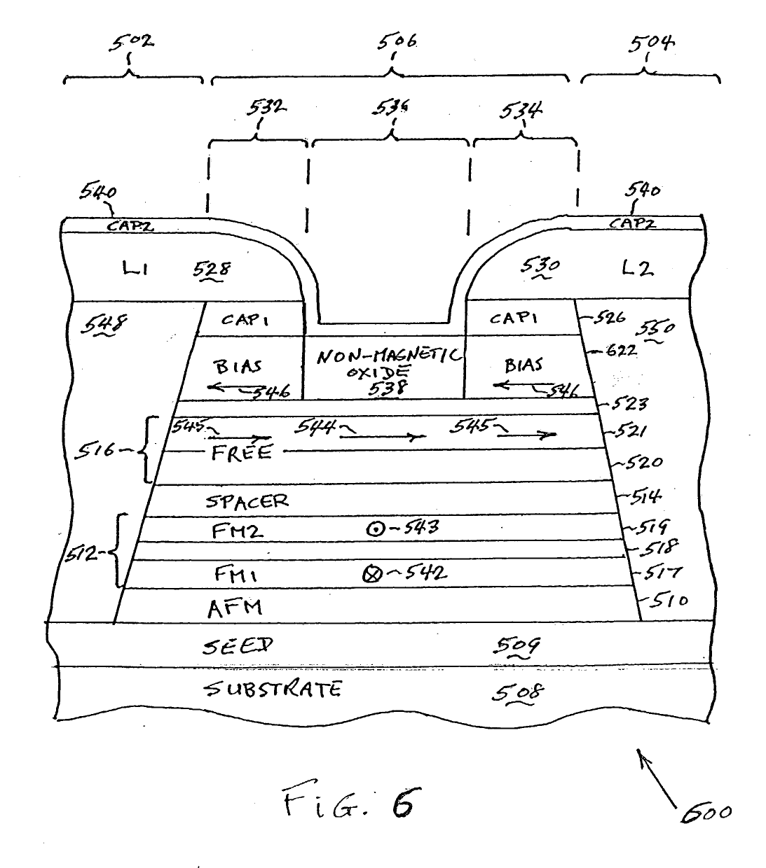

FIG. 5 depicts an air bearing surface (ABS) view, not to scale, of a lead overlay spin valve sensor 500 according to a first embodiment of the present invention. The SV sensor 500 comprises end regions 502 and 504 separated from each other by a central region 506. The substrate 508 can be any suitable substance including glass, semiconductor material, or a ceramic material such as alumina (Al₂O₃). The seed layer 509 is a layer or layers deposited to modify the crystallographic texture or grain size of the subsequent layers. An antiferromagnetic (AFM) layer 510 is deposited over the seed layer. An antiparallel (AP)-pinned layer 512, a conductive 20 spacer layer 514 and a free layer 516 are deposited sequentially over the AFM layer 510. The AFM layer may have a thickness sufficient to provide the desired exchange properties to act as a pinning layer for the AP-pinned layer 512. In the present embodiment, the AFM layer 510 is thinner than desirable for a pinning layer and is used to provide an additional seed layer to help promote improved properties of the subsequent layers of the sensor. The AP-pinned layer 512 comprises a first ferromagnetic (FM1) layer 517 and a second ferromagnetic (FM2) layer 519 separated by an antiparallel coupling (APC) layer 518 that allows the FM1 layer 517 and the FM2 layer 519 to be strongly AP-coupled as indicated by the antiparallel magnetizations 542 (represented by the tail of an arrow pointing into the paper) and 543 (represented by the head of an arrow pointing out of the paper), respectively. The AP-coupled layer 512 is designed to be a self-pinned layer as is known to the art. The free layer 516 comprises a ferromagnetic first free sublayer 520 of Co—Fe and a ferromagnetic second free sublayer 521 of Ni—Fe. Alternatively, the free layer 516 may be formed of a single layer, preferably Co—Fe, or may have a trilayer structure comprising a first sublayer of Co—Fe, a second sublayer of Ni—Fe and a third sublayer of Co—Fe.

A bias layer 522 separated from the free layer 516 by an APC layer 523 comprises a ferromagnetic first bias sublayer 524 of Co—Fe deposited over the APC layer 523 and a ferromagnetic second bias sublayer 525 of Ni—Fe deposited over the first bias sublayer 524. Modeling suggests that the bias layer should be in the range of 5-50%, preferably about 20%, magnetically thicker than the free layer for optimum stabilization of the free layer in the passive regions 532 and 534. The first bias sublayer of Co—Fe provides strong AP-coupling of the bias layer 522 to the free layer 516. The second bias sublayer of Ni—Fe has a negative magnetostriction coefficient that interacts with the lapping-induced stress anisotropy of the sensor stack to provide strong self-pinning of the bias layer 522. The APC layer 523 allows the bias layer 522 to be strongly AP-coupled to the free layer 516. A first cap layer 526 is formed on the bias layer 522.

First and second leads L1 528 and L2 530 are formed over the cap layer 526 in the passive regions 532 and 534 and over the end regions 502 and 504 overlapping the central region 506 of the sensor in the first and second passive regions. A space between L1 528 and L2 530 in the central region 506 of the sensor defines the track width region 536 which defines the track width of the read head and which can have submicron dimensions. The first cap layer 536 in the track width region 536 between L1 and L2 is removed by a sputter etch and/or a reactive ion etch (RIE) process followed by a sputter etch and oxidation process to convert the ferromagnetic materials of bias layer 522 into a nonmagnetic oxide layer 538 in the track width region 536. A second cap layer 540 is formed over the leads L1 528 and L2 530 in the end regions 502, 504 and the passive regions 532, 534 and over the nonmagnetic oxide layer 538 in the track width region 536.

The AP-pinned layer 512 has the magnetizations of the FMI layer 517 and the FM2 layer 519 pinned in directions perpendicular to the ABS as indicated by arrow tail 542 and arrow head 543 pointing into and out of the plane of the paper, respectively. In the track width region 536, the magnetization of the free layer 516 indicated by the arrow 544 is the net magnetization of the ferromagnetically coupled first and second free sublayers 520 and 521 and is free to rotate in the presence of an external (signal) magnetic field. The magnetization 544 is preferably oriented parallel to the ABS in the absence of an external magnetic field. In the first and second passive regions 532 and 534, the free layer 516 is strongly AP-coupled to the bias layer 522.

The magnetization 546 of the bias layer 522 in the first and second passive regions 532 and 534 is the net magnetization of the ferromagnetically coupled first and second bias sublayers 524 and 525. Due to the presence of the APC layer 523 which allows the free layer 516 to be strongly AP-coupled to the bias layer 522 in the passive regions, the magnetization 546 of the bias layer is oriented antiparallel to the magnetization 545 of the free layer. The effect of this AP-coupling is longitudinal stabilization of the free layer 516 in the passive regions 532 and 534 since the magnetization 545 does not rotate in response to external fields thus inhibiting undesirable side reading on the rotating magnetic disk.

End region layers 548 and 550 abutting the spin valve layers may be formed of electrically insulating material such as alumina, or alternatively, may be formed of a suitable hard bias material in order to provide a longitudinal bias field to the free layer 516 to ensure a single magnetic domain state in the free layer. An advantage of having the hard bias material forming the end region layers 548 and 550 is that these layers are remote from the track width region 536 so that they do not magnetically stiffen the magnetization 544 of the free layer in this region, which stiffening makes the free layer insensitive to field signals from the rotating magnetic disk.

Leads L1 528 and L2 530 deposited in the end regions 502 and 504, respectively, provide electrical connections for the flow of a sensing current IS from a current source to the SV sensor 500. A signal detector which is electrically connected to the leads senses the change of resistance due to change in magnetization direction induced in the free layer 516 by the external magnetic field (e.g., field generated by a data bit stored on a rotating magnetic disk). The external field acts to rotate the direction of the magnetization 544 of the free layer 516 relative to the direction of the magnetization 543 of the pinned layer 519 which is preferably pinned perpendicular to the ABS.

The SV sensor 500 is fabricated in a magnetron sputtering or an ion beam sputtering system to sequentially deposit the multilayer structure shown in FIG. 5. The sputter deposition process is carried out in the presence of a longitudinal magnetic field of about 40 Oe. The seed layer 509 is formed on the substrate 508 by sequentially depositing a layer of alumina (Al₂O₃) having a thickness of about 30 Å, a layer of Ni—Fe—Cr having a thickness of about 25 Å and a layer of Ni—Fe having a thickness of about 8 Å. The AFM layer 510 of Pt—Mn, having a thickness in the range of 4-150 Å, is deposited over the seed layer 509. The AP-pinned layer 512 is formed over the AFM layer by sequentially depositing the FM1 layer 517 of Co—Fe having a thickness of about 19 Å, the APC layer 518 of ruthenium (Ru) having a thickness of about 8 Å and the FM2 layer 519 of Co—Fe having a thickness of about 19 Å. The spacer layer 514 of copper (Cu) having a thickness of about 20 Å is deposited over the FM2 layer 519 and the free layer 516 is deposited over the spacer layer 514 by first depositing the first free sublayer 520 of Co—Fe having a thickness of about 10 Å followed by the second free sublayer 521 of Ni—Fe having a thickness of about 20 Å. The APC layer 523 of Ru having a thickness of about 8 Å is deposited over the second free sublayer 521. The bias layer 522 is deposited over the APC layer 523 by first depositing the first bias sublayer 524 of Co—Fe having a thickness of about 10 Å followed by the second bias sublayer 525 of Ni—Fe having a thickness of about 25 Å. A first cap layer 526 deposited over the bias layer 522 comprises a first sublayer of tantalum (Ta) having a thickness of about 20 Å and a second sublayer of ruthenium (Ru) having a thickness of about 20 Å over the first sublayer. Alternatively, the first cap layer may be formed of a single layer of tantalum (Ta) having a thickness of 40 Å.

After the deposition of the central region 506 is completed, photoresist is applied and exposed in a photolithography tool to mask SV sensor 500 in the central region 506 and then developed in a solvent to expose end regions 502 and 504. The layers in the unmasked end regions 502 and 504 are removed by ion milling and end region layers 548 and 550 of alumina (Al₂O₃) are deposited in the end regions. Alternatively, longitudinal hard bias layers may be formed in the end regions 502 and 504 in order to provide a longitudinal bias field to the free layer 516 to ensure a single magnetic domain state in the free layer.

Photoresist and photolithography processes are used to define the track width region 536 in the central region 506 of the SV sensor 500. First and second leads L1 528 and L2 530 of rhodium (Rh) having a thickness in the range 200-600 Å are deposited over the end regions 502 and 504 and over the unmasked first cap layer 526 and in the first and second passive regions 532 and 534 which provide the desired lead/sensor overlap. After removal of the photoresist mask 604 in the track width region 536, the leads L1 528 and L2 530 are used as masks for a sputter etch and/or a reactive ion etch (RIE) process to remove the first cap layer 526 in the track width region 536. After removal of the first cap layer, the exposed portion of the bias layer 522 in the track width region 536 is sputter etched with an oxygen containing gas to convert the ferromagnetic bias layers materials into a nonmagnetic oxide layer 538. The second cap layer 540 of rhodium (Rh), or alternatively ruthenium (Ru), having a thickness of about 40 Å is deposited over the leads L1 528 and L2 530 in the end regions 502 and 504 and the passive regions 532 and 534 and over the nonmagnetic oxide layer 538 in the track field region 536.

After fabrication of the structure of the SV sensor 500 is completed, the AP-pinned layer 512 and the self-pinned bias layer 522 are set so that the AP-pinned layer 512 is pinned in a transverse direction and the bias layer 522 is pinned in a longitudinal direction. At the row level of the fabrication process, the AP-pinned layer 512 and the bias layer 522 of the SV sensor 500 may be simultaneously set by application, at ambient temperature, of a magnetic field of about 13 kOe oriented in the plane of the layers and in a direction making an angle with the ABS, preferably about 45 degrees. Alternatively, the AP-pinned layer and the bias layer may be set independently by first applying a magnetic field of about 13 kOe at an angle of about 45 degrees with the ABS to set the AP-pinned layer and subsequently applying a magnetic field of about 5 kOe in a longitudinal direction of the sensor to set the bias layer. If the AFM layer 510 is used to pin the magnetization of the AP-pinned layer 512, a different setting procedure is used. At the wafer level of the fabrication process, the SV sensor is heated to about 265° C. in the presence of a transverse magnetic field (or, alternatively, a magnetic field at an angle of about 45 degrees with the ABS) of about 13 kOe and held for about 5 hours to set the AFM layer and the AP-pinned layer. With the magnetic field still applied, the sensor is cooled before removing the magnetic field. Subsequently, at the row level of the process, a magnetic field of about 5 kOe in a longitudinal direction of the sensor is applied at ambient temperature to set the bias layer.

An alternative process for defining the AP-coupled antiparallel tabs in the passive regions may be used to replace the process of sputter etching with an oxygen containing gas to oxidize ferromagnetic bias layer materials in the track width region. In the alternative process, the step of using a sputter etch and/or reactive ion etch (RIE) process to remove the first cap layer 526 in the track width region 536 is continued to also remove the bias layer 522 in the track width region. To protect the free layer 516 from the sputter etch and RIE process a secondary ion mass spectrometer (SIMS) installed in the vacuum chamber of the etching system is used to provide endpoint detection for the ruthenium (Ru) forming the spacer layer 523. The second cap layer 540 of rhodium (Rh), or alternatively ruthenium (Ru), having a thickness of about 20 Å is deposited over the leads L1 528 and L2 530 in the end regions 502 and 504 and the passive regions 532 and 534 and over the spacer layer 523 in the track field region 536.

An advantage of the self-pinned bias layer 522 of the present invention is that by eliminating the need for an AFM layer to pin the magnetization of the bias layer the thickness of the SV sensor 500 is significantly reduced. To achieve the desired high data density, e.g. in the range of 150 Gb/in², the entire SV sensor must fit into a narrow read gap having a width of about 600 Å or less. Elimination of the need for an AFM layer, typically having a thickness of about 150 Å, is important in achieving the desired geometry for a high resolution read head.

Another advantage of the bias layer 522 of the present invention is the bilayer structure comprising a first bias sublayer 524 adjacent to the APC layer 523 and a second bias sublayer 525 formed of material having a negative magnetostriction coefficient. The bilayer structure of the bias layer allows improved optimization of the requirements for negative magnetostriction to achieve a strong longitudinal pinning field and for a strong antiferromagnetic coupling energy (J_{AF}>0.5 erg/cm²) to the free layer. The use of a bilayer to form the bias layer 522 allows both the materials properties of the two materials and their relative thickness to be chosen to optimize pinning and the coupling energy. The first bias sublayer 524 is preferably formed of a material having a small value of λₛ and strong antiferromagnetic coupling energy. Ferromagnetic alloys containing cobalt (Co) such as Co—Fe, Co—Fe—Ni and Co—Nb may be used since cobalt containing alloys are known to provide strong antiferromagnetic coupling across an APC layer. Co—Fe layers having iron content in the range 10-40 atomic percent % have small positive or negative values of λₛ making them attractive for use in forming the first bias sublayer. Alternatively, Co—Fe—Ni alloys having nickel content in the range of 0-30 atomic percent may be used. The second bias sublayer 525 is formed of a material having a high negative magnetostriction coefficient in order to bring the net As of the bias layer 522 to the desired design point. Suitable materials for forming the second bias sublayer include nickel (Ni), Ni—Fe, Ni—Fe—Co and Ni—Fe—Co—O. Nickel and nickel containing alloys of this group having a nickel content greater than about 80 atomic percent % have negative magnetostriction coefficients desirable for use in the second bias sublayer.

### SECOND EXAMPLE

FIG. 6 depicts an air bearing surface (ABS) view, not to scale, of a lead overlay spin valve sensor 600 according to a second embodiment of the present invention. The SV sensor 600 differs from the SV sensor 500 shown in FIG. 5 in having a bias layer 622 comprising a single layer instead of the bilayer structure of bias layer 522. The bias layer 622 in first and second passive regions 532 and 534 is separated from a free layer 516 by an APC layer 523 which allows the bias layer 622 to be strongly AP-coupled to the free layer. Strong self-pinning of the AP-coupled bias layer/APC layer/free layer structure is achieved by forming the bias layer 622 of material having a high value of negative magnetostriction coefficient. The stress induced uniaxial anisotropy field, H_{σ}, proportional to the product of the magnetostriction coefficient, λ, of the bias layer and the lapping-induced compressive stress, σ, of the SV sensor layers provides the desired strong self-pinning. With the single bias layer structure of this embodiment, the material used to form bias layer 622 should provide reasonably strong antiferromagnetic coupling to the free layer. Suitable materials for forming the bias layer 622 include Co—Nb and Ni—Fe. In particular, the preferred compositions of these alloys in atomic % are Co₉₀—Nb₁₀ and Ni₉₀—Fe₁₀. When Ni—Fe is used to form the bias layer, the free layer 516 may be formed of a single layer, preferably Co—Fe, or may have a trilayer structure comprising a first sublayer of Co—Fe, a second sublayer of Ni—Fe and a third sublayer of Co—Fe. The rest of the structure of the SV sensor 600 and the method of fabrication is the same as described herein above with respect to the SV sensor 500.

### Discussion

For the present invention, the role of the ferromagnetic bias layer is to control both the amplitude and polarity of the response of the free layer magnetization, both inside the active track-width and in the immediately proximate passive regions adjacent to the active track-width, when excited by transverse magnetic fields which are strongest in this same region at or near the boundary between active and passive regions of the free layer. Such magnetic fields are characteristic of those from magnetic bits recorded on either track immediately adjacent to the track which is normally being read/detected by the SV sensor of the present invention. These off-track signal fields can potentially constitute a significant source of noise/interference which would substantially degrade the recording channel's bit error rate with a read sensor of insufficient cross-track spatial resolution of its magnetic sensitivity.

In the present invention, the ferromagnetic bias layer is chosen to be magnetically thicker than the free layer to which it is strongly AP-coupled. With the magnetically thicker bias layer, the net response of the free layer/bias layer couple to the aforementioned off-track signal fields is that their combined magnetization will rotate so as to align the magnetization in the bias layer to become more parallel with that of the transverse component of the signal field. For sufficiently strong AP-coupling, this implies that the free layer magnetization in the proximate end regions will tend to rotate in antiparallel alignment with this signal field. In contrast, the remanent component of the off-track signal fields that extends into the active track-width will tend to rotate the free layer magnetization in the active track-width to be parallel with the transverse signal fields. These competing effects tend to negate and/or cancel out the net magnetization rotation of the free layer and the resultant net resistance change in response to such off-track signal fields.

Simultaneously, the response of the free layer magnetization to on-track signal fields (strongest inside the active track-width of the sensor) is not significantly lessened, or stiffened, by the presence of the bias layer, since the magnetization of the bias layer will tend to follow (in antiparallel fashion) the rotation of the magnetization of the free layer in the passive regions. Due to the interlayer exchange stiffness of the free layer, the magnetization of the free layer in the passive region responds with the same orientation as that of the desired magnetization rotation of the free layer in the active region. Therefore, the combined reaction of the free layer/bias layer couple is to provide a high degree of spatially selective cross-track sensitivity (or cross-track resolution) without degradation of on-track absolute signal levels. Further, this mechanism, primarily driven by the internal magnetostatics of the free layer, will tend to be reasonably scale invariant as the size of the active track-width of the read sensor is reduced to support ever greater areal recording density.

Although strong AP-coupling tends to align the free layer and bias layer magnetizations to always remain approximately antiparallel, this mechanism itself does not distinguish as to the absolute orientation of these magnetization vectors. For proper operation of the present invention, the quiescent magnetic state of the magnetization of the free layer, both in the active track-width and immediately adjacent passive end regions, should be stably aligned in a direction that is longitudinal with the geometry of the free layer (i.e., parallel to the track-width direction) and therefore orthogonal to the direction of the transverse signal fields from the recorded bits. Therefore, the total uniaxial anisotropy field of both the free and bias ferromagnetic layers should have their easy axes of magnetization aligned parallel to the longitudinal axis of the SV sensor.

It should be understood that the self-pinned antiparallel coupled tabs using a bias layer having a net negative magnetostriction coefficient in the passive regions 532 and 534 of the present invention may be used with any bottom SV sensor (sensor having the pinned layers located near the bottom of the stacked layers). In the bottom spin valve structure, the free layer can be easily AP-coupled to a bias layer and oxidation of the ferromagnetic bias layer to form a nonmagnetic oxide in the track width region can be easily accomplished. In particular, the self-pinned antiparallel coupled bias tabs in the lead/sensor overlap regions may be used with AFM pinning simple pinned or AP-pinned SV sensors.

While the present invention has been particularly shown and described with reference to the preferred embodiments, it will be understood by those skilled in the art that various changes in form and detail may be made without departing from the spirit, scope and teaching of the invention. Accordingly, the disclosed invention is to be considered merely as illustrative and limited only as specified in the appended claims.

We claim:

1. A spin valve (SV) sensor having first and second passive regions and a central track width region transversely disposed between said first and second passive regions, said SV sensor comprising:
a pinned layer;
a ferromagnetic free layer;
a spacer layer sandwiched between said pinned layer and said free layer;
a bias layer in said first and second passive regions, said bias layer having a high uniaxial anisotropy caused by stressing said bias layer; and
an antiparallel coupling layer sandwiched between said free layer and said bias layer for providing strong antiparallel coupling between said bias layer and said free layer in the first and second passive regions.

2. The SV sensor as recited in claim 1 wherein the bias layer is made of material having a negative magnetostriction coefficient.

3. The SV sensor as recited in claim 2 wherein the bias layer is selected from a group of materials consisting of Co—Nb and Ni—Fe.

4. The SV sensor as recited in claim 1 wherein the bias layer is made of Co₉₀—Nb₁₀.

5. The SV sensor as recited in claim 1 wherein the bias layer is made of Ni₉₀—Fe₁₀.

6. The SV sensor as recited in claim 1 wherein the bias layer comprises first and second bias sublayers, wherein the first bias sublayer is sandwiched between the antiparallel coupling layer and the second bias sublayer.

7. The SV sensor as recited in claim 6 wherein the first bias sublayer is chosen from a group of materials consisting of Co—Fe and Co—Fe—Ni.

8. The SV sensor as recited in claim 6 wherein the second bias sublayer is made of material having a negative magnetostriction coefficient.

9. The SV sensor as recited in claim 8 wherein the second bias sublayer is chosen from a group of materials consisting of nickel (Ni), Ni—Fe, Ni—Co and Ni—Fe—Co—O.

10. The SV sensor as recited in claim 1 wherein the bias layer has a thickness in the range of 5-50% magnetically thicker than the thickness of the free layer.

11. A magnetic read/write head comprising:
a write head including:
at least one coil layer and an insulation stack, the coil layer being embedded in the insulation stack;
first and second pole piece layers connected at a back gap and having pole tips with edges forming a portion of an air bearing surface (ABS);
the insulation stack being sandwiched between the first and second pole piece layers; and
a write gap layer sandwiched between the pole tips of the first and second pole piece layers and forming a portion of the ABS;
a read head including:
a spin valve (SV) sensor, the SV sensor being sandwiched between first and second read gap layers, the SV sensor having first and second passive regions
and a central track width region transversely disposed between said first and second
passive regions, said SV sensor comprising:
a pinned layer;
a ferromagnetic free layer;
a spacer layer sandwiched between said pinned layer and said free layer;
a bias layer in said first and second passive regions, said bias layer having a high uniaxial anisotropy caused by stressing said bias layer; and
an antiparallel coupled layer sandwiched between said free layer and said bias layer for providing strong antiparallel coupling between said bias layer and said free layer in the first and second passive regions; and
an insulation layer disposed between the second read gap layer of the read head and the first pole piece layer of the write head.

12. The magnetic read/write head as recited in claim 11 wherein the bias layer is made of material having a negative magnetostriction coefficient.

13. The magnetic read/write head as recited in claim 12 wherein the bias layer is selected from a group of materials consisting of Co—Nb and Ni—Fe.

14. The magnetic read/write head as recited in claim 11 wherein the bias layer is made of Co₉₀—Nb₁₀.

15. The magnetic read/write head as recited in claim 11 wherein the bias layer is made of Ni₉₀—Fe₁₀.

16. The magnetic read/write head as recited in claim 11 wherein the bias layer comprises first and second bias sublayers, wherein the first bias sublayer is sandwiched between the antiparallel coupling layer and the second bias sublayer.

17. The magnetic read/write head as recited in claim 16 wherein the first bias sublayer is chosen from a group of materials consisting of Co—Fe and Co—Fe—Ni.

18. The magnetic read/write head as recited in claim 16 wherein the second bias sublayer is made of material having a negative magnetostriction coefficient.

19. The magnetic read/write head as recited in claim 18 wherein the second bias sublayer is chosen from a group of materials consisting of nickel (Ni), Ni—Fe, Ni—Co and Ni—Fe—Co—O.

20. The magnetic read/write head as recited in claim 11 wherein the bias layer has a thickness in the range of 5-50% magnetically thicker than the thickness of the free layer.

21. A disk drive system comprising:
a magnetic recording disk;
a magnetic read/write head for magnetically recording data on the magnetic recording disk and for sensing magnetically recorded data on the magnetic recording disk, said magnetic read/write head comprising:
a write head including:
at least one coil layer and an insulation stack, the coil layer being embedded in the insulation stack;
first and second pole piece layers connected at a back gap and having pole tips with edges forming a portion of an air bearing surface (ABS);
the insulation stack being sandwiched between the first and second pole piece layers; and
a write gap layer sandwiched between the pole tips of the first and second pole piece layers and forming a portion of the ABS;
a read head including:
a spin valve (SV) sensor, the SV sensor being sandwiched between first and second read gap layers, the SV sensor having first and second passive regions and a central track width region transversely disposed between said first and second passive regions, said SV sensor comprising:
a pinned layer;
a ferromagnetic free layer;
spacer layer sandwiched between said pinned layer and said free layer;
a bias layer in said first and second passive regions, said bias layer having a high uniaxial anisotropy caused by stressing said bias layer; and
an antiparallel coupled layer sandwiched between said free layer and said ferromagnetic bias layer for providing strong antiparallel coupling between said bias layer and said free layer in the first and second passive regions;
an antiferromagnetic (AFM) layer adjacent to said ferromagnetic bias layer, said AFM layer exchange coupled to the ferromagnetic bias layer to provide a pinning field to the bias layer; and
an insulation layer disposed between the second read gap layer of the read head and the first pole piece layer of the write head; and
an actuator for moving said magnetic read/write head across the magnetic disk so that the read/write head may access different regions of the magnetic recording disk; and
a recording channel coupled electrically to the write head for magnetically recording data on the magnetic recording disk and to the SV sensor of the read head for detecting changes in resistance of the SV sensor in response to magnetic fields from the magnetically recorded data.

22. The disk drive system as recited in claim 21 wherein the bias layer is made of material having a negative magnetostriction coefficient.

23. The disk drive system as recited in claim 22 wherein the bias layer is selected from a group of materials consisting of Co—Nb and Ni—Fe.

24. The disk drive system as recited in claim 21 wherein the bias layer is made of Co₉₀—Nb₁₀.

25. The disk drive system as recited in claim 21 wherein the bias layer is made of Ni₉₀—Fe₁₀.

26. The disk drive system as recited in claim 21 wherein the bias layer comprises first and second bias sublayers, wherein the first bias sublayer is sandwiched between the antiparallel coupling layer and the second bias sublayer.

27. The disk drive system as recited in claim 26 wherein the first bias sublayer is chosen from a group of materials consisting of Co—Fe and Co—Fe—Ni.

28. The disk drive system as recited in claim 26 wherein the second bias sublayer is made of material having a negative magnetostriction coefficient.

29. The disk drive system as recited in claim 28 wherein the second bias sublayer is chosen from a group of materials consisting of nickel (Ni), Ni—Fe, Ni—Co and Ni—Fe—Co—O.

30. The disk drive system as recited in claim 21 wherein the bias layer has a thickness in the range of 5-50% magnetically thicker than the thickness of the free layer.
